(19) United States
(12) Patent Application Publication
(10) Pub. No.: US 2011/0249091 A1
(43) Pub. Date: Oct. 13, 2011

(54) VIDEO SIGNAL PROCESSING APPARATUS AND VIDEO SIGNAL PROCESSING METHOD

(75) Inventor: Kouki KISHIMOTO, Osaka (JP)

(73) Assignee: PANASONIC CORPORATION, Osaka (JP)

(21) Appl. No.: 13/163,982

(22) Filed: Jun. 20, 2011

Related U.S. Application Data
(63) Continuation of application No. PCT/JP2010/005048, filed on Aug. 12, 2010.

(30) Foreign Application Priority Data
Sep. 30, 2009 (JP) 2009-228980

(51) Int. Cl. H04N 13/00

(52) U.S. Cl. 348/43; 348/E13.064

(57) ABSTRACT

Switching between a two-dimensional (2D) video signal and a three-dimensional (3D) video signal is seamlessly performed without causing blackouts. A video signal processing apparatus includes: an input unit which obtains a 2D video signal and a 3D video signal having different frame rates; and an output unit which (i) converts at least one of the frame rates of the 2D video signal and the 3D video signal obtained by the input unit into a predetermined display frame rate, (ii) outputs the 2D video signal at the predetermined display frame rate during a first period, and (iii) outputs the 3D video signal at the predetermined display frame rate during a second period that is consecutive to the first period.

### CROSS REFERENCE TO RELATED APPLICATION(S)

This is a continuation application of PCT application No. PCT/JP2010/005048 filed on Aug. 12, 2010, designating the United States of America.

### BACKGROUND OF THE INVENTION

(1) Field of the Invention

The present invention relates to video signal processing apparatuses, and in particular, to a video signal processing apparatus for displaying two-dimensional video signals and three-dimensional video signals.

(2) Description of the Related Art

There is a conventional three-dimensional (3D) video display apparatus which displays 3D video including left-eye images and right-eye images and provides a viewer with 3D perception. There is also a conventional 3D video display apparatus which includes two display modes, one that is a two-dimensional (2D) display mode and the other that is a 3D display mode, and switches between 2D video and 3D video for display (for example, see Japanese Patent Application Publication No. 2005-136541). There is parallax between a left-eye image and a right-eye image. The left-eye image and the right-eye image are, for example, images generated by two cameras positioned at different spots.

In the 3D display mode, the 3D video display apparatus displays 3D video, which provides the viewer with 3D perception, by displaying the left-eye images and the right-eye images using a predetermined scheme. For example, the 3D video display apparatus alternately displays left-eye images and right-eye images on a per frame basis.

### SUMMARY OF THE INVENTION

However, a problem exists in the conventional techniques where a blackout occurs at the time of switching between 2D video and 3D video. It is caused because 2D video and 3D video have different synchronization formats.

The present invention has been conceived to solve the problem, and has an object to provide a video signal processing apparatus and a video signal processing method which are capable of seamlessly switching between a 2D video signal and a 3D video signal without causing blackouts.

In order to achieve the object, a video signal processing apparatus according to the present invention includes: an input unit which obtains a two-dimensional (2D) video signal and a three-dimensional (3D) video signal, the 2D video signal having a frame rate different from a frame rate of the 3D video signal; and an output unit which (i) converts at least one of the frame rates of the 2D video signal and the 3D video signal obtained by said input unit into a predetermined display frame rate, (ii) outputs the 2D video signal at the predetermined display frame rate during a first period, and (iii) outputs the 3D video signal at the predetermined display frame rate during a second period that is consecutive to the first period.

According to the configuration, the frame rate is the same before and after the switching between the 2D video signal and the 3D video signal. Thus, it is possible to seamlessly switch between the 2D video signal and the 3D video signal without causing blackouts.

It may be that the input unit obtains the 2D video signal having a frame rate that is half of the predetermined display frame rate and the 3D video signal having the predetermined display frame rate, and the output unit converts the frame rate of the 2D video signal into the predetermined display frame rate.

Accordingly, it is possible for a display panel (3D display panel) which is capable of displaying a 3D video signal to display a 2D video signal.

It may also be that the 2D video signal includes a plurality of 2D images, the video signal processing apparatus further includes a parallax determining unit which determines a displacement amount for displacing a position of pixels of each of the 2D images in a horizontal direction, and the output unit (i) generates a plurality of images including parallax information by displacing the position of the pixels of each of the 2D images by the displacement amount determined by the parallax determining unit, and (ii) alternately outputs a picture of each of the generated images including parallax information and a picture of each of the 2D images during the first period.

According to the configuration, the display panel can display the 2D video signal as 3D video; and thus, for example, the display panel can always display 3D video even when the 3D video signal is switched to the 2D video signal.

It may also be that the 2D video signal includes a plurality of 2D images, and the output unit outputs a picture of each of the 2D images twice in a row during the first period.

It may also be that the 3D video signal includes a plurality of left-eye images and a plurality of right-eye images, and the output unit outputs one of (i) a picture of each of the left-eye images and (ii) a picture of each of the right-eye images, twice in a row during the second period.

According to the configurations, the display panel can display the 3D video signal as 2D video; and thus, for example, the display panel can always display 2D video even when the 2D video signal is switched to the 3D video signal.

It may also be that the input unit obtains the 2D video signal having the predetermined display frame rate, and the 3D video signal having a frame rate twice as high as the predetermined display frame rate, and the output unit converts the frame rate of the 3D video signal into the predetermined display frame rate.

Accordingly, the display panel (2D display panel) which is capable of displaying a 2D video signal can display a 3D video signal.

It may also be that the 3D video signal includes a plurality of left-eye images and a plurality of right-eye images, and the output unit outputs one of (i) a picture of each of the left-eye images and (ii) a picture of each of the right-eye images, once during the second period.

According to the configuration, the display panel can display the 3D video signal as 2D video; and thus, for example, the display panel can always display 2D video even when the 2D video signal is switched to the 3D video signal.

The present invention may also be implemented not only as the above video signal processing apparatus, but also as a method including the processing units of the video signal processing apparatus as steps. The present invention may also be implemented as a program causing a computer to execute these steps. Furthermore, the present invention may also be implemented as a recording medium such as a computer-readable Compact Disc-Read Only Memory (CD-ROM) storing the program, and as information, data or a signal indicating the program. Such program, information, data and signal may be distributed over communications network such as the Internet.

In addition, part or all of the elements of each video signal processing apparatus may be configured with a single system Large Scale Integration (LSI). The system LSI, which is a super-multifunctional LSI manufactured by integrating elements on a single chip, is specifically a computer system which includes a microprocessor, a ROM, a RAM (Random Access Memory) and the like.

According to the video signal processing apparatus and the video signal processing method in the present invention, it is possible to seamlessly switch between a 2D video signal and a 3D video signal without causing blackouts.

### FURTHER INFORMATION ABOUT TECHNICAL BACKGROUND TO THIS APPLICATION

The disclosure of Japanese Patent Application No. 2009-228980 filed on Sep. 30, 2009 including specification, drawings and claims is incorporated herein by reference in its entirety.

The disclosure of PCT application No. PCT/JP2010/005048 filed on Aug. 12, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram illustrating a configuration of a video signal processing system which includes video signal processing apparatuses according to one embodiment;

FIG. 2 is a block diagram illustrating an example of a configuration of the video signal processing apparatus according to the embodiment;

FIG. 3A is a conceptual diagram showing a case where 3D video is output to a 3D display panel as 3D video;

FIG. 3B is a conceptual diagram showing a case where 3D video is output to a 3D display panel as 2D video;

FIG. 3C is a conceptual diagram showing a case where 3D video is output to a 2D display panel as 2D video;

FIG. 4 is a block diagram illustrating another example of a configuration of the video signal processing apparatus according to the embodiment;

FIG. 5A is a conceptual diagram showing a case where 2D video is output to a 3D display panel as 3D video;

FIG. 5B is a conceptual diagram showing a case where 2D video is output to a 3D display panel as 2D video;

FIG. 5C is a conceptual diagram showing a case where 2D video is output to a 2D display panel as 2D video;

FIG. 6 is a flowchart of an example of operations of the video signal processing apparatus according to the embodiment;

FIG. 7A is a conceptual diagram showing an example of an output video signal when an input video signal is switched from 3D video to 2D video;

FIG. 7B is a conceptual diagram showing an example of an output video signal when an input video signal is switched from 2D video to 3D video;

FIG. 7C is a conceptual diagram showing an example of an output video signal when an input video signal is switched from 2D video to 3D video; and

FIG. 8 is an external view of an example of a digital television and a digital video recorder each of which includes the video signal processing apparatuses according to the embodiment.

### DESCRIPTION OF THE PREFERRED EMBODIMENT(S)

Hereinafter, detailed descriptions are given to a video signal processing apparatus and a video signal processing method according to the present invention based on an embodiment, with reference to the drawings.

The video signal processing apparatus according to the embodiment is characterized in including an input unit which obtains a video signal including a 2D video signal and a 3D video signal having different frame rates; and an output unit which (i) converts at least one of the frame rates of the 2D video signal and the 3D video signal into a predetermined display frame rate, (ii) outputs the 2D video signal at the predetermined display frame rate during a first period, and (iii) outputs the 3D video signal at the predetermined display frame rate during a second period that is consecutive to the first period.

First, description is given to a video signal processing system which includes the video signal processing apparatus according to the embodiment.

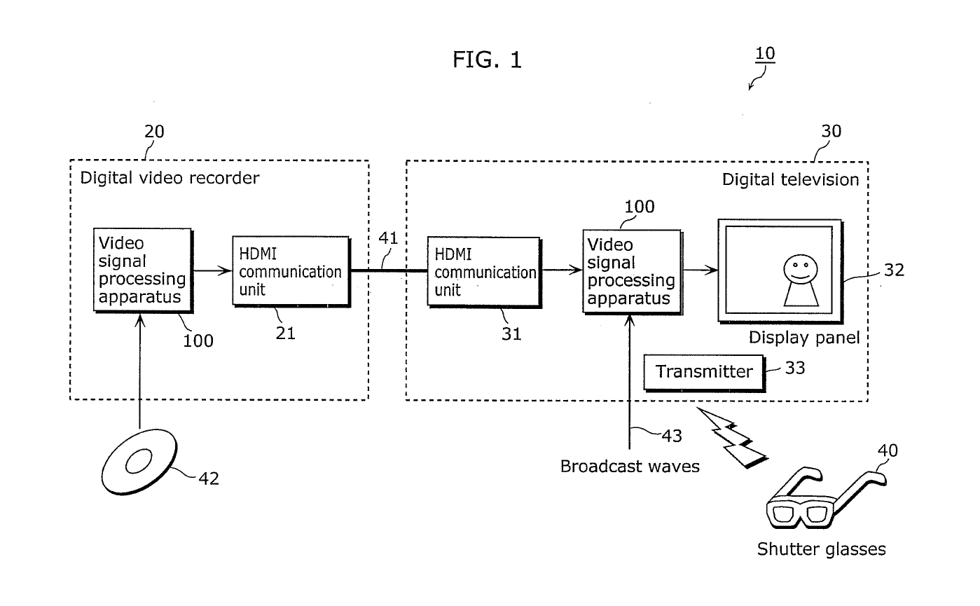

FIG. 1 is a block diagram illustrating a configuration of a video signal processing system 10 which includes video signal processing apparatuses 100 according to the embodiment.

The video signal processing system 10 shown in FIG. 1 includes a digital video recorder 20, a digital television 30, and shutter glasses 40. The digital video recorder 20 and the digital television 30 are interconnected via a High Definition Multimedia Interface (HDMI) cable 41.

The digital video recorder 20 processes 2D video signals and 3D video signals recorded in a recording medium 42, and outputs the processed video signals to the digital television 30 via the HDMI cable 41. The recording medium 42 is, for example, an optical disc such as a blu-ray disc (BD), a magnetic disk such as a hard disk drive (HDD), or a non-volatile memory.

Here, processing of the video signals refers to processing performed by the video signal processing apparatus 100 included in the digital video recorder 20. Examples of the processing include decoding, converting frame rate, and converting image size, which will be described later.

The digital television 30 processes 2D video signals and 3D video signals input from the digital video recorder 20 via the HDMI cable 41 or included in broadcast waves 43, to display 2D video included in the processed 2D video signals and 3D video included in the processed 3D video signals. The broadcast waves 43 are, for example, digital terrestrial television broadcasting or digital satellite broadcasting.

The shutter glasses 40 are glasses worn by a viewer for viewing 3D video, and are, for example, liquid crystal shutter glasses. The shutter glasses 40 include a left-eye liquid crystal shutter and a right-eye liquid crystal shutter. The shutter glasses 40 are capable of controlling opening and closing of the shutters in synchronization with the video displayed on the digital television 30.

The digital video recorder 20 may process 2D video signals and 3D video signals included in the broadcast waves 43 or obtained through communications network such as the Internet. The digital video recorder 20 may also process 2D video signals and 3D video signals input from an external device via an external input terminal (not shown).

Similarly, the digital television 30 may also process 2D video signals and 3D video signals recorded in the recording medium 42. The digital television 30 may also process the 2D video signals and the 3D video signals input from an external device other than the digital video recorder 20 via an external input terminal (not shown).

The digital video recorder 20 and the digital television 30 may also be interconnected via a standardized cable other than the HDMI cable 41 or via wireless communications network.

In the following, detailed descriptions are given to the configuration of the digital video recorder 20 and the digital television 30. First, the digital video recorder 20 is described.

As shown in FIG. 1, the digital video recorder 20 includes the video signal processing apparatus 100 and an HDMI communication unit 21.

The video signal processing apparatus 100 obtains 2D video signals and 3D video signals recorded in the recording medium 42. The video signal processing apparatus 100 performs, for example, decoding, frame rate conversion, and image size conversion on the obtained 2D video signals and 3D video signals. Detailed configuration and operations of the video signal processing apparatus 100 are described later.

The HDMI communication unit 21 outputs the 2D video signals and the 3D video signals processed by the video signal processing apparatus 100 to the digital television 30 via the HDMI cable 41.

The digital video recorder 20 may store the processed 2D video signals and 3D video signals into a storage unit (such as an HDD or a non-volatile memory) included in the digital video recorder 20. The digital video recorder 20 may also store the processed 2D video signals and 3D video signals onto a removable recording medium (such as an optical disk).

When the digital video recorder 20 is connected to the digital television 30 via a means other than the HDMI cable 41, the digital video recorder 20 may also include a communication unit corresponding to the means instead of the HDMI communication unit 21. For example, the digital video recorder 20 includes a wireless communication unit when the connection means is wireless communications network. When the connection means is a cable in accordance with another standard, the digital video recorder 20 includes a communication unit which complies with the standard. It may also be that the digital video recorder 20 includes multiple communication units and switches the communication units.

Next, the digital television 30 is described.

As shown in FIG. 1, the digital television 30 includes an HDMI communication unit 31, the video signal processing apparatus 100, a display panel 32, and a transmitter 33.

The HDMI communication unit 31 obtains the 2D video signals and the 3D video signals output from the HDMI communication unit 21 of the digital video recorder 20, and outputs the obtained 2D video signals and 3D video signals to the video signal processing apparatus 100.

The video signal processing apparatus 100 obtains the 2D video signals and the 3D video signals included in the broadcast waves 43. Alternatively, the video signal processing apparatus 100 obtains the 2D video signals and the 3D video signals output from the HDMI communication unit 31. The video signal processing apparatus 100 processes the obtained 2D video signals and 3D video signals. For example, the video signal processing apparatus 100 performs, for example, decoding, frame rate conversion, and image size conversion on the obtained 2D video signals and 3D video signals. Detailed configuration and operations of the video signal processing apparatus 100 are described later.

The display panel 32 displays 2D video and 3D video respectively included in the 2D video signals and the 3D video signals that are processed by the video signal processing apparatus 100. The display panel 32 is a 3D display panel which is capable of displaying video at a high frame rate such as 120 fps. The display panel 32 may also be a 2D display panel which is capable of displaying video at a normal frame rate such as 60 fps.

The transmitter 33 controls the opening and closing of the shutters of the shutter glasses 40 using wireless communications.

In the similar manner to the digital video recorder 20, when the digital television 30 is connected to the digital video recorder 20 via a means other than the HDMI cable 41, the digital television 30 may include a communication unit corresponding to the means instead of the HDMI communication unit 31.

Here, descriptions are given to the 3D video displayed on the display panel 32, and to a method for synchronizing the display panel 32 and the shutter glasses 40.

The 3D video includes left-eye images and right-eye images between which parallax is present. When the left-eye images and the right-eye images respectively and selectively enter the left eye and the right eye of the viewer, the viewer can view the video with 3D perception. For example, a 3D video signal alternately includes left-eye images and right-eye images on a per frame basis (or on a per field basis). For example, the 3D video signal has a frame rate of 120 fps, and the scanning method thereof is a progressive scheme.

The display panel 32 receives the 3D video signal and alternately displays each left-eye image and each right-eye image on a per frame basis. Here, the transmitter 33 controls the shutter glasses 40 such that the left-eye liquid crystal shutter is opened and the right-eye liquid crystal shutter is closed while the display panel 32 displays the left-eye image. The transmitter 33 also controls the shutter glasses 40 such that the right-eye liquid crystal shutter is opened and the left-eye liquid crystal shutter is closed while the display panel 32 displays the right-eye image. Accordingly, the left-eye image and the right-eye image selectively and respectively enter the left-eye and the right eye of the viewer.

In such a manner, the display panel 32 displays the left-eye images and the right-eye images by temporally switching them. In the above example, the left-eye image and the right-eye image are switched per frame; however, they may be switched per a plurality of frames.

Next, descriptions are given to the detailed structure and operations of the video signal processing apparatus 100 according to the embodiment. In the following, description is given to the video signal processing apparatus 100 included in the digital television 30. The configuration and operations of the video signal processing apparatus 100 included in the digital video recorder 20 are also the same.

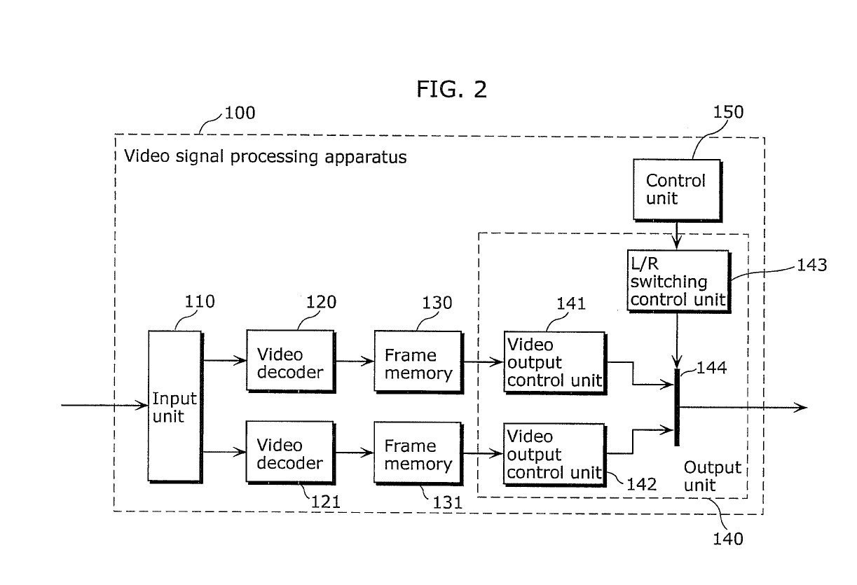

FIG. 2 is a block diagram illustrating an example of a configuration of the video signal processing apparatus 100 according to the embodiment. As shown in FIG. 2, the video signal processing apparatus 100 includes an input unit 110, video decoders 120 and 121, frame memories 130 and 131, an output unit 140, and a control unit 150.

The input unit 110 obtains, as input video signals, a 2D video signal and a 3D video signal having different frame rates. For example, the input unit 110 obtains the 2D video signal and the 3D video signal included in the broadcast waves 43.

The input unit 110 outputs the 2D video signal to one of the video decoders 120 and 121. The input unit 110 also divides the 3D video signal into left-eye images and right-eye images, and outputs the left-eye images to the video decoder 120, and the right-eye images to the video decoder 121.

When the 3D video signal is already separated into the left-eye video signal including only left-eye images and the right-eye video signal including only right-eye images, the input unit 110 outputs the left-eye video signal to the video decoder 120 and the right-eye video signal to the video decoder 121 without dividing the 3D video signal.

The 2D video signal includes, for example, a plurality of 2D images compressed coded in accordance with MPEG-4 AVC/H.264 standard (hereinafter, referred to as H.264). More specifically, in the case of the interlace scheme, the 2D video signal includes a top field consisting of odd-numbered lines and a bottom field consisting of even-numbered lines. In the case of the progressive scheme, the 2D video signal includes a plurality of 2D image frames.

The 3D video signal includes left-eye images and right-eye images which are compressed coded in accordance with H. 264 standard and between which parallax is present. The left-eye image and the right-eye image are images generated by two image capturing devices positioned at different spots capturing images of the same subject.

The input unit 110 obtains the 2D video signal and the 3D video signal at different periods. More specifically, the input unit 110 obtains the 2D video signal during a first input period, and obtains the 3D video signal during a second input period that is consecutive to the first input period. The first input period may be ahead of the second input period, or may be vice versa.

In other words, the video signal input to the input unit 110 is a video signal which is switched from the 2D video signal into the 3D video signal, or from the 3D video signal into the 2D video signal. For example, the input unit 110 obtains, as a 3D video signal, a video signal in which content such as a movie is compressed coded, and obtains, as a 2D video signal, a video signal in which commercial such as advertisement information attached to the content are compressed coded.

The video decoders 120 and 121 decode the compressed coded 2D video signal and 3D video signal. For example, the video decoder 120 decodes the compressed coded 2D signal to generate a plurality of 2D images, and stores the generated 2D images into the frame memory 130.

The video decoder 120 also decodes the compressed coded left-eye images included in the 3D video signal to generate decoded left-eye images, and stores the generated left-eye images into the frame memory 130. The video decoder 121 decodes the compressed coded right-eye images included in the 3D video signal to generate decoded right-eye images, and stores the generated right-eye images into the frame memory 131.

The frame memories 130 and 131 are memories for storing images generated by the video decoders 120 and 121. The video signal processing apparatus 100 according to the embodiment may store the images generated by the video decoders 120 and 121 into an external memory, instead of including the frame memories 130 and 131.

The output unit 140 converts the frame rate of at least one of the 2D video signal and the 3D video signal into a predetermined display frame rate. The output unit 140 outputs the 2D video signal at the display frame rate during the first period, and outputs the 3D video signal at the display frame rate during the second period. More specifically, in the case where the 2D video signal is switched into the 3D video signal, as well as the case where the 3D video signal is switched into the 2D video signal, the output unit 140 outputs the video signal at the same frame rate.

The first period is a period during which the 2D video signal input to the input unit 110 is output. The second period is a period during which the 3D video signal input to the input unit 110 is output. The second period is a period that is immediately before or after the first period.

As described later, the output unit 140 outputs the 2D video signal and the 3D video signal input to the input unit 110 so that the display panel 32 displays 3D video or 2D video. In other words, the output unit 140 may output the 2D video signal input to the input unit 110 so that the display panel 32 displays 3D video, or output the 3D video signal input to the input unit 110 so that the display panel 32 displays 2D video.

More specifically, under the control of the control unit 150, the output unit 140 reads the images stored in the frame memories 130 and 131, and outputs the images. As shown in FIG. 2, the output unit 140 includes video output control units 141 and 142, an L/R switching control unit 143, and a selector 144.

The video output control unit 141 reads images from the frame memory 130, and outputs the images to the selector 144. Since the frame memory 130 stores 2D images or left-eye images, the video output control unit 141 outputs the 2D images or the left-eye images.

The video output control unit 142 reads images from the frame memory 131, and outputs the images to the selector 144. Since the frame memory 131 stores right-eye images, the video output control unit 142 outputs the right-eye images.

The L/R switching control unit 143 controls the selector 144 to determine which images should be output, either the images output from the video output control unit 141 or the images output from the video output control unit 142.

Under the control of the L/R switching control unit 143, the selector 144 selects, on a per picture basis, either (i) the 2D images or the left-eye images output from the video output control unit 141 or (ii) the right-eye images output from the video output control unit 142, and outputs the selected images to outside.

The control unit 150 controls the video signal processing apparatus 100 according to the embodiment. For example, the control unit 150 controls the L/R switching control unit 143 based on whether the display panel 32 is a 3D display panel or a 2D display panel. More specifically, when the display panel 32 is a 2D display panel, the control unit 150 controls the L/R switching control unit 143 so that the selector 144 outputs only either the left-eye images or the right-eye images. When the display panel 32 is a 3D display panel, the control unit 150 controls the L/R switching control unit 143 in accordance with an instruction from a user or the like.

The control unit 150 also controls the L/R switching control unit 143 based on whether the video signal obtained by the input unit 110 is a 2D video signal or a 3D video signal. In other words, when the input unit 110 obtains a 2D video signal, the control unit 150 controls the L/R switching control unit 143 so that the selector 144 always selects only one of the video output control units 141 and 142. More specifically, the L/R switching control unit 143 selects the video output control unit corresponding to the video decoder to which the input unit 110 has output the 2D video signal. The video decoder 120 corresponds to the frame memory 130 and the video output control unit 141. The video decoder 121 corresponds to the frame memory 131 and the video output control unit 142.

The control unit 150 further controls the L/R switching control unit 143 based on whether the video that the user wants to view is 3D video or 2D video.

According to the configuration, even when switching is performed between the 3D video signal and the 2D video signal, the video signal processing apparatus 100 according to the embodiment is capable of outputting the 2D video signal and the 3D video signal at the same frame rate before and after the switching.

It may also be that the input unit 110 outputs the left-eye images to the video decoder 121, and outputs the right-eye images to the video decoder 120.

In the following, descriptions are given to processing performed when the input unit 110 obtains a 2D video signal and when the input unit 110 obtains a 3D video signal. First, description is given to the processing performed when the input unit 110 obtains a 3D video signal.

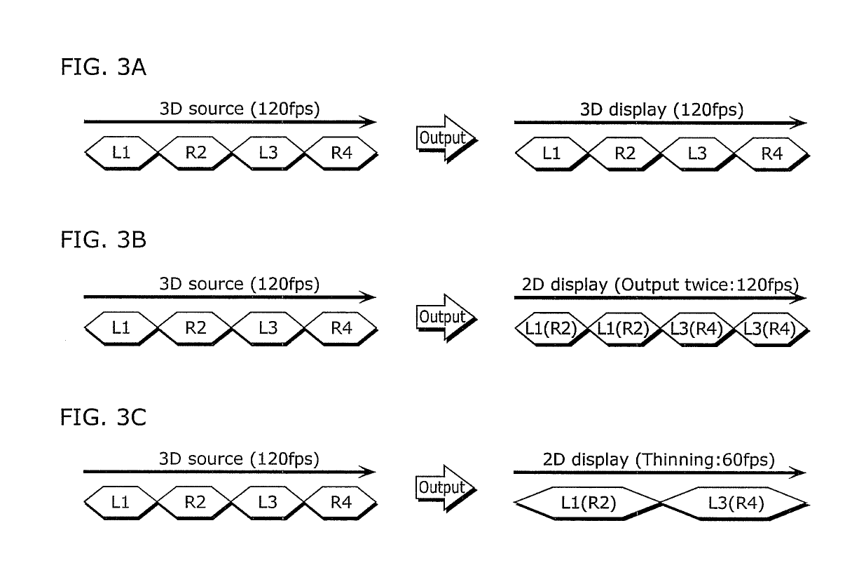

First, description is given to the case where an input 3D video signal is output to the 3D display panel as 3D video, with reference to FIG. 3A. Here, outputting as 3D video refers to outputting a video signal which includes left-eye images and right-eye images that parallax is present therebetween and which displays video on the display panel such that the viewer has 3D perception. The 3D display panel is an example of the display panel 32 which is capable of displaying video at a high frame rate. For example, the display frame rate of the 3D display panel is 120 fps.

As shown in FIG. 3A, the input unit 110 obtains a 3D video signal which includes left-eye images (L1, L3, . . . ) and right-eye images (R2, R4, . . . ) alternately on a per picture basis. For example, the frame rate of the 3D video signal is equal to the display frame rate which is 120 fps. The frame rate of the 3D video signal is the number of pictures included per second. In the case of the interlace scheme, the frame rate of the 3D video signal is the number of fields (total of the top fields and the bottom fields) included per second.

The left-eye images (L1, L3, . . . ) are decoded by the video decoder 120, and then stored in the frame memory 130. The right-eye images (R2, R4, . . . ) are decoded by the video decoder 121, and then stored in the frame memory 131.

The output unit 140 reads the left-eye images and the right-eye images respectively stored in the frame memories 130 and 131, and alternately output them on a per picture basis. The frame rate at the time of output is the display frame rate when video is displayed on the display panel 32. In the example shown in FIG. 3A, the frame rate is 120 fps.

Since the frame rate of the input 3D video signal is the same as the frame rate of the output 3D video signal, the selector 144 alternately selects and outputs, on a per picture basis, the left-eye images output from the video output control unit 141 and the right-eye images output from the video output control unit 142.

In such a manner, the output unit 140 alternately outputs each picture of the left-eye images and each picture of the right-eye images at the display frame rate (120 fps) of the 3D display panel. Since the display panel 32 alternately displays the left-eye images and the right-eye images, the user is capable of viewing 3D images. Accordingly, the video signal processing apparatus 100 is capable of outputting the input 3D video signal to the 3D display panel as 3D video.

Next, description is given to the case where an input 3D video signal is output to the 3D display panel as 2D video, with reference to FIG. 3B. Here, outputting as 2D video refers to outputting a video signal which includes 2D images having no parallax, and which displays, on the display panel, ordinary 2D images providing the viewer with no 3D perception.

As shown in FIG. 3B, the 3D video signal obtained by the input unit 110 is the same as that in FIG. 3A.

The output unit 140 outputs either the left-eye images or the right-eye images. More specifically, the output unit 140 reads the left-eye images stored in the frame memory 130 or the right-eye images stored in the frame memory 131, and outputs each left-eye image or each right-eye image twice in a row.

More specifically, the L/R switching control unit 143 controls the selector 144 so that the selector 144 selects only either the left-eye images output from the video output control unit 141 or the right-eye images output from the video output control unit 142.

For example, when the selector 144 selects the left-eye images, the video output control unit 141 reads the left-eye images from the frame memory 130, and outputs each the left-eye image twice in a row. More specifically, the video output control unit 141 outputs each picture of the left-eye images twice in a row. As a result, as shown in FIG. 3B, the output unit 140 outputs a picture of each of the left-eye images twice in a row (L1, L1, L3, L3 . . . ).

In such a manner, the output unit 140 outputs only either the left-eye images or the right-eye images at the display frame rate (120 fps) of the 3D display panel. Since the display panel 32 displays only the left-eye images or the right-eye images, that is, only images having no parallax therebetween, the user is capable of viewing 2D images. Accordingly, the video signal processing apparatus 100 is capable of outputting the input 3D video signal to the 3D display panel as 2D video.

Next, description is given to the case where an input 3D video signal is output to the 2D display panel as 2D video, with reference to FIG. 3C. The 2D display panel is an example of the display panel 32 which is capable of displaying video at a frame rate lower than that of the 3D display panel. For example, the display frame rate of the 2D display panel is 60 fps.

As shown in FIG. 3C, the 3D video signal obtained by the input unit 110 is the same as that in FIG. 3A. However, the display panel 32 is a 2D display panel which has a display frame rate of 60 fps; and thus, the frame rate (120 fps) of the 3D video signal is twice as high as that of the display frame rate.

The output unit 140 thins either the left-eye images or the right-eye images, and outputs only the non-thinned images. In other words, the output unit 140 outputs each picture of the left-eye images or of the right-eye images once. More specifically, the output unit 140 reads the left-eye images stored in the frame memory 130 or the right-eye images stored in the frame memory 131, and outputs the read pictures. More specifically, the L/R switching control unit 143 controls the selector 144 so that the selector 144 selects only either the left-eye images output from the video output control unit 141 or the right-eye images output from the video output control unit 142.

For example, when the selector 144 selects the left-eye images, the video output control unit 141 reads the left-eye images from the frame memory 130, and outputs the read left-eye images. Here, the frame rate of the output left-eye images is the display frame rate of the display panel 32. As a result, as shown in FIG. 3C, the output unit 140 outputs each picture of the left-eye images once (L1, L3 . . . ).

In such a manner, the output unit 140 outputs only either the left-eye images and the right-eye images at the display frame rate (60 fps) of the 2D display panel. Since the display panel 32 displays only the left-eye images or the right-eye images, that is, only images having no parallax therebetween, the user is capable of viewing 2D images. Accordingly, the video signal processing apparatus 100 is capable of outputting the input 3D video signal to the 2D display panel as 2D video.

When the 3D video signal is output as 2D video as shown in FIG. 3B and FIG. 3C, the left-eye images or the right-eye images are not output; and thus, it may be that one of the video decoders 120 and 121 does not decode the left-eye images or the right-eye images which are not to be output. This reduces the processing amount, and further reduces power consumption.

Next, description is given to the processing performed when the input unit 110 obtains a 2D video signal.

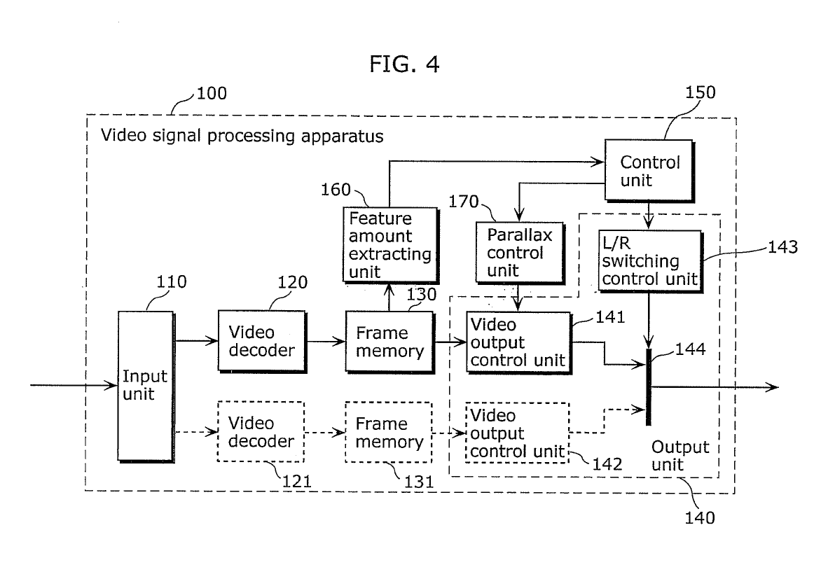

FIG. 4 is a block diagram illustrating an example of another configuration of the video signal processing apparatus 100 according to the embodiment. More specifically, FIG. 4 illustrates the elements that are preferably included in the video signal processing apparatus 100 when a 2D video signal is input.

As shown in FIG. 4, the video signal processing apparatus 100 further includes a feature amount extracting unit 160 and a parallax control unit 170. Here, since a 2D video signal is input, it may be that the video signal processing apparatus 100 does not include the video decoder 121, the frame memory 131, and the video output control unit 142.

The feature amount extracting unit 160 detects the feature amount of an image to obtain parallax information to be added to the 2D image. For example, the feature amount extracting unit 160 detects motion or extracts an object, as a detection of the feature amount.

The feature amount extracting unit 160 performs motion detection. The feature amount extracting unit 160 considers that a region having a larger motion is a region closer to the image capturing position, and considers that a region having a smaller motion is a region farther from the image capturing position. By doing so, the feature amount extracting unit 160 determines the distance between the image capturing position and each region. The feature amount extracting unit 160 outputs the determined distance as parallax information to the parallax control unit 170. The feature amount extracting unit 160 may determine the distance per object, by extracting objects and detecting motion per object.

The parallax control unit 170 is an example of a parallax determining unit, and determines, for each region or each object, displacement amount for displacing the region or the object in a horizontal direction, based on the parallax information. More specifically, the parallax control unit 170 determines the displacement amount to be larger as the distance, determined by the feature extracting unit 160, between the region and the image capturing position is closer, and determines the displacement amount to be smaller as the distance, determined by the feature extracting unit 160, between the region and the image capturing position is farther.

The video output control unit 141 generates an image including parallax information by displacing the pixel positions of the 2D image read from the frame memory 130 by the displacement amount determined by the parallax control unit 170. There is a parallax between the generated image including parallax information and the 2D image. More specifically, assuming that the 2D image is a left-eye image, the image including parallax information corresponds to a right-eye image.

When the 2D video signal is not output as 3D video, it may be that the video signal processing apparatus 100 does not include the feature amount extracting unit 160 and the parallax control unit 170. Even in this case, it is possible that the video output control unit 141 converts the frame rate of the 2D video signal into the display frame rate, and the output unit 140 outputs the 2D video signal at the display frame rate. Thus, blackouts do not occur at the time of switching between the 2D video signal and the 3D video signal.

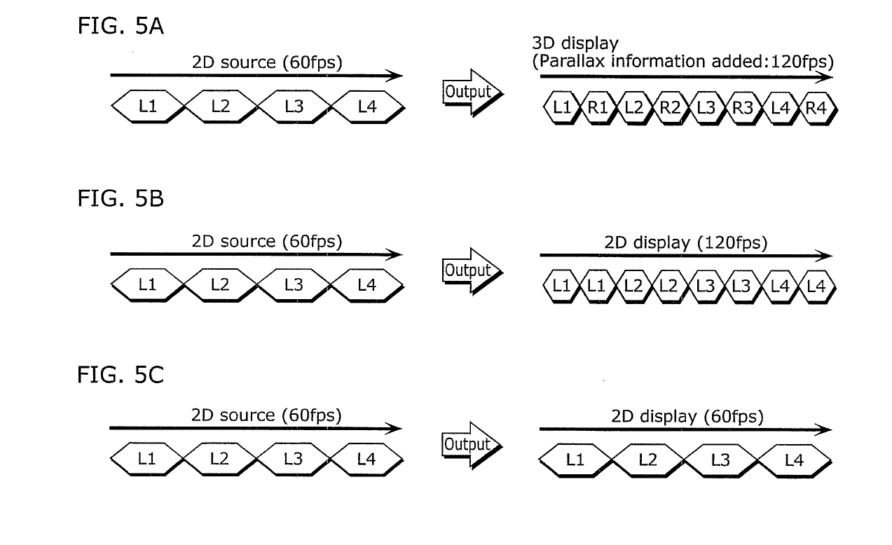

In the following, description is given to the case where an input 2D video signal is output to the 3D display panel as 3D video, with reference to FIG. 5A. The 3D display panel is an example of the display panel 32 which is capable of displaying video at a high frame rate. For example, the display frame rate of the 3D display panel is 120 fps.

As shown in FIG. 5A, the input unit 110 obtains a 2D video signal including a plurality of 2D images (L1, L2, L3 . . . ). For example, the frame rate of the 2 video signal is equal to half of the display frame rate, which is 60 fps. The 2D images are decoded by the video decoder 120, and then stored in the frame memory 130. Here, the feature amount extracting unit 160 reads the 2D images from the frame memory 130, and detects feature amount from the read 2D images to obtain parallax information.

The output unit 140 reads the 2D images stored in the frame memory 130, and outputs the 2D images on a per picture basis. Here, the parallax control unit 170 displaces the pixel positions of the 2D images (L1, L2, L3 . . . ) in the horizontal direction based on the parallax information obtained by the feature amount extracting unit 160, to cause the video output control unit 141 to generate images including parallax information (R1, R2, R3 . . . ). Here, the parallax control unit 170 may displace the pixel positions of the 2D images by different amount per region or per object. In such a manner, when the 2D images are assumed as left-eye images, the output unit 140 generates images including parallax information as pseudo right-eye images, and alternately outputs the 2D images and the generated images including parallax information (L1, R1, L2, R2 . . . ).

More specifically, the video output control unit 141 outputs, to the selector 144, the 2D images with no parallax modification as left-eye images and the images including parallax information as right-eye images on a per picture basis. The L/R switching control unit 143 controls the selector 144 so that the selector 144 selects the video output control unit 141.

In such a manner, the output unit 140 alternately outputs a picture of each 2D image and a picture of each image including parallax information. The frame rate at the time of output is the display frame rate when video is displayed on the display panel 32. In the example shown in FIG. 5A, the frame rate is 120 fps. Since the display panel 32 alternately displays the left-eye images and the right-eye images, the user is capable of viewing 3D images. Accordingly, the video signal processing apparatus 100 is capable of outputting the input 2D video signal to the 3D display panel as 3D video.

Next, description is given to the case where an input 2D video signal is output to the 3D display panel as 2D video, with reference to FIG. 5B.

As shown in FIG. 5B, the 2D video obtained by the input unit 110 is the same as that in FIG. 5A.

The output unit 140 outputs each picture of 2D images twice in a row. As shown in FIG. 5B, since the display frame rate is 120 fps which is twice as high as the frame rate (60 fps) of the input 2D video signal, the output unit 140 outputs each 2D image twice in a row (L1, L1, L2, L2).

How many times each 2D image is output in a row is determined based on the ratio of the frame rate of the input video to the display frame rate. More specifically, when the display frame rate is N times as high as the frame rate of the input video, each picture of the 2D images is output N times in a row.

For example, the L/R switching control unit 143 controls the selector 144 so that the selector 144 selects the video output control unit 141. The video output control unit 141 outputs, to the selector 144, each picture of 2D images twice in a row.

In such a manner, the output unit 140 outputs the 2D images at the display frame rate (120 fps) of the 3D display panel. Since the display panel 32 displays ordinary 2D images, the user is capable of viewing 2D images. Accordingly, the video signal processing apparatus 100 outputs the input 2D video signals to the 3D display panel as 2D video.

Next, description is given to the case where an input 2D video signal is output to the 2D display panel as 2D video, with reference to FIG. 5C.

As shown in FIG. 5C, the 2D video obtained by the input unit 110 is the same as that in FIG. 5A. However, since the display panel 32 is a 2D display panel which has a display frame rate of 60 fps, the frame rate (60 fps) of the 2D video signal is equal to the display frame rate.

The output unit 140 reads the 2D images stored in the frame memory 130, and outputs each picture of the 2D images. The frame rate at the time of output is the display frame rate when video is displayed on the display panel 32. In the example shown in FIG. 5C, the frame rate is 60 fps.

Since the frame rate of the input 2D video signal is the same as the frame rate of the 2D video signal to be output, the selector 144 selects and outputs the left-eye images output from the video output control unit 141 on a per picture basis (L1, L2, L3 . . . ).

In such a manner, the output unit 140 outputs a picture of each 2D image at the display frame rate (60 fps) of the 2D display panel. Since the display panel 32 displays 2D images having no parallax therebetween, the user is capable of viewing 2D images. Accordingly, the video signal processing apparatus 100 is capable of outputting the input 2D video signal to the 2D display panel as 2D video.

Next, description is given to the operations of the video signal processing apparatus 100 according to the embodiment. More specifically, description is given to a method of controlling the output unit 140 performed by the control unit 150.

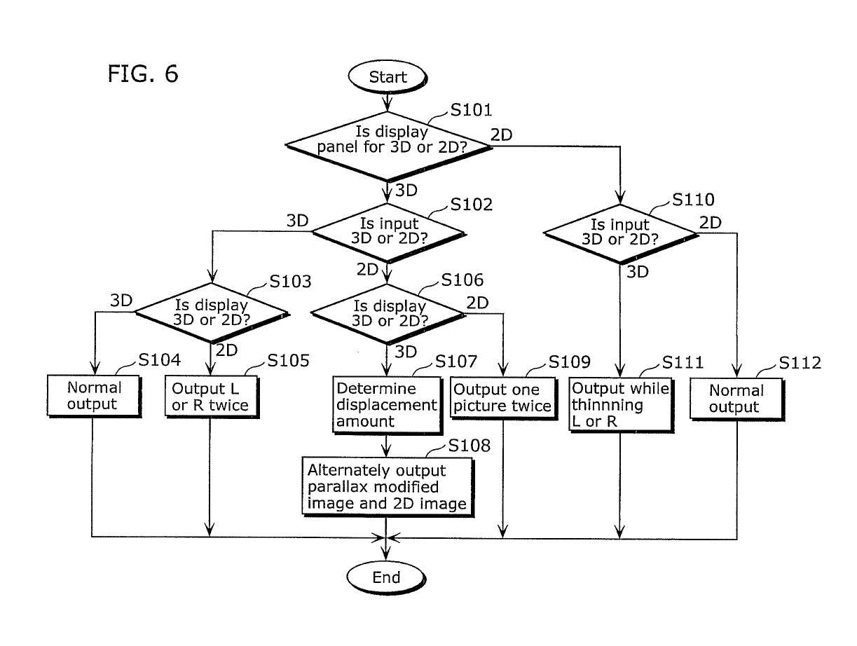

FIG. 6 is a flowchart of an example of the operations of the control unit 150 and the output unit 140 included in the video signal processing apparatus 100 according to the embodiment.

First, the control unit 150 determines whether the display panel 32 is a 3D display panel or a 2D display panel (S101). In other words, the control unit 150 determines the display frame rate of the display panel 32. When the video signal processing apparatus 100, such as the video signal processing apparatus 100 included in the digital video recorder 20, is not connected to the display panel 32, the control unit 150 determines the output frame rate of the video to be output to be, for example, a predetermined frame rate.

When the display panel 32 is a 3D display panel (3D in S101), the control unit 150 determines whether an input video signal is a 3D video signal or a 2D video signal (S102). When the input video signal includes a 3D video signal and a 2D video signal, the control unit 150 determines whether the source of the video to be output is a 3D video signal or a 2D video signal.

When the input video signal is a 3D video signal (3D in S102), the control unit 150 determines whether the video to be displayed on the display panel 32 is 3D video or 2D video (S103). When the video signal processing apparatus 100 is not connected to the display panel 32, the control unit 150 determines which one of the 3D video and the 2D video is to be displayed on another display panel.

When the video to be displayed on the display panel 32 is 3D video (3D in S103), the output unit 140 alternately outputs, as shown in FIG. 3A, a picture of each left-eye image and a picture of each right-eye image (S104). When the video to be displayed on the display panel 32 is 2D video (2D in S103), the output unit 140 outputs, as shown in FIG. 3B, a picture of each left-eye image or a picture of each right-eye image twice in a row (S105).

When the display panel 32 is a 3D display panel, and an input video signal is a 2D video signal (2D in S102), the control unit 150 determines whether the video to be displayed on the display panel 32 is 3D video or 2D video (S106). When the video signal processing apparatus 100 is not connected to the display panel 32, the control unit 150 determines which one of the 3D video and the 2D video is to be displayed on another display panel.

When the video to be displayed on the display panel 32 is 3D video (3D in S106), the parallax control unit 170 determines the displacement amount based on the parallax information (S107). The output unit 140 generates an image including parallax information by displacing the pixel positions of the 2D image in the horizontal direction by the displacement amount determined by the parallax control unit 170, and, as shown in FIG. 5A, alternately outputs a picture of each 2D image and a picture of each image including parallax information (S108).

When the video to be displayed on the display panel 32 is 2D video (2D in S106), the output unit 140 outputs, as shown in FIG. 5B, a picture of each 2D image twice in a row (S109).

When the display panel 32 is a 2D display panel (2D in S101), the control unit 150 determines whether an input video signal is a 3D video signal or a 2D video signal (S110). When the input video signal includes a 3D video signal and a 2D video signal, the control unit 150 determines whether the source of the video to be output is a 3D video signal or a 2D video signal.

When the input video signal is a 3D video signal (3D in S110), the output unit 140 thins, as shown in FIG. 3C, either the left-eye images or the right-eye images, and outputs only the non-thinned ones (S111). When the input video signal is a 2D video signal (2D in S110), the output unit 140 outputs, as shown in FIG. 5C, each picture of the 2D images (S112).

In such a manner, in the video signal processing apparatus 100 according to the embodiment, the control unit 150 controls the method of outputting video signals based on the display panel 32, the input video signal, and the video to be displayed on the display panel 32. More specifically, the control unit 150 controls the output method by determining whether the display panel 32 is a 3D display panel or a 2D display panel, whether the input video signal is a 3D video signal or a 2D video signal, and whether the video to be displayed is 3D video or 2D video.

The determination of the display panel 32, the input video signal, and the video to be displayed may be performed in any orders. The flowchart shown in FIG. 6 is merely an example.

No matter whether a 2D video signal is input or a 3D video signal is input, the video signal processing apparatus 100 according to the embodiment is capable of outputting video at the display frame rate corresponding to the display panel 32 by converting the frame rate in the manner described above. Hence, even when the 2D video signal is switched to the 3D video signal, or the 3D video signal is switched to the 2D video signal, it is possible to output video at the same frame rate.

In the following, description is given to an output video signal when an input video signal is switched from a 2D video signal to a 3D video signal, or from a 3D video signal to a 2D video signal.

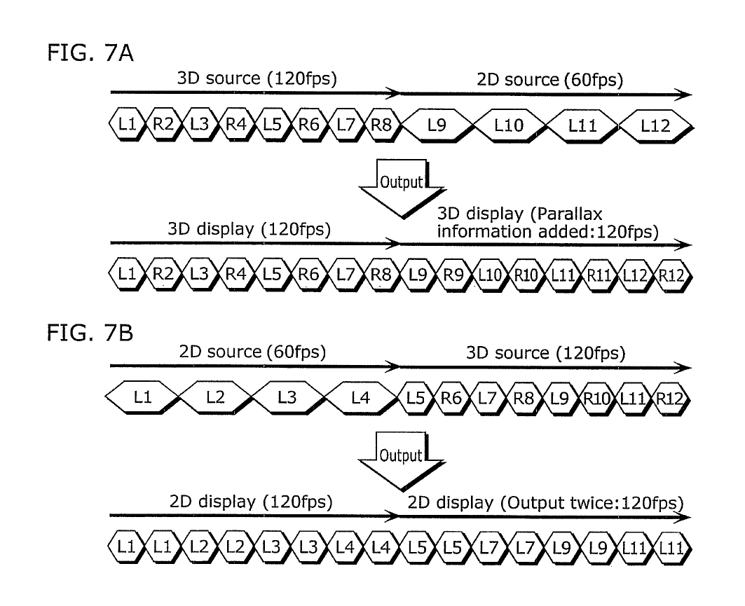

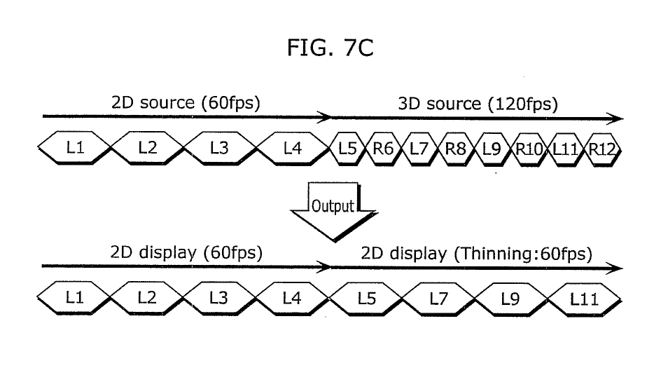

FIG. 7A is a conceptual diagram showing an example of an output video signal when an input video signal is switched from a 3D video signal to a 2D video signal.

As shown in FIG. 7A, the input unit 110 receives a 3D video signal at the frame rate of 120 fps during a first input period, and receives a 2D video signal at the frame rate of 60 fps during a second input period that is consecutive to the first input period. The 3D video signal includes a plurality of left-eye images (L1, L3, L5 . . . ) and a plurality of right-eye images (R2, R4, R6 . . . ). The 2D video signal includes a plurality of 2D images (L9, L10, L11 . . . ).

Here, for example, it is assumed that the display panel 32 is a 3D display panel, that is, the display frame rate is 120 fps, and the display panel 32 displays 3D video.

Since the frame rate of the 3D video signal is the display frame rate, the output unit 140 outputs the 3D video signal during the first output period at the frame rate with no change. Since the frame rate of the 2D video signal is half of the display frame rate, the output unit 140 generates images including parallax information (R9, R10, R11 . . . ) from the 2D images (L9, L10, L11 . . . ), and alternately outputs the generated images including parallax information and the 2D images during the second output period that is consecutive to the first output period.

Accordingly, the output unit 140 converts the frame rate of the 2D video signal that is half of the display frame rate into the display frame rate, to output the 2D video signal at the display frame rate. Here, as shown in FIG. 7A, the output unit 140 outputs the 2D video signal and the 3D video signal at the same display frame rate so that the display panel 32 displays 3D video. As a result, blackouts do not occur at the time of switching from the 3D video signal to the 2D video signal.

FIG. 7B is a conceptual diagram showing an example of an output video signal when an input video signal is switched from 2D video to 3D video.

As shown in FIG. 7B, the input unit 110 receives a 2D video signal at the frame rate of 60 fps during the first input period, and receives a 3D video signal at the frame rate of 120 fps during the second input period. The 2D video signal includes a plurality of 2D images (L1, L2, L3 . . . ). The 3D video signal includes a plurality of left-eye images (L5, L7, L8 . . . ) and a plurality of right-eye images (R6, R8, R10 . . . ).

Here, for example, it is assumed that the display panel 32 is a 3D display panel, that is, the display frame rate is 120 fps, and the display panel 32 displays 2D video.

Since the frame rate of the 2D video signal is half of the display frame rate, the output unit 140 outputs each picture of the 2D images twice in a row during the first output period. Furthermore, since the frame rate of the 3D video signal is the display frame rate, the output unit 140 outputs either each picture of the left-eye images or each picture of the right-eye images twice in a row.

Accordingly, the output unit 140 converts the frame rate of the 2D video signal that is half of the display frame rate into the display frame rate, to output the 2D video signal at the display frame rate. Here, as shown in FIG. 7B, the output unit 140 outputs the 2D video signal and the 3D video signal at the same display frame rate so that the display panel 32 displays 2D video. As a result, blackouts do not occur at the time of switching from the 2D video signal to the 3D video signal.

FIG. 7C is a conceptual diagram showing an example of an output video signal when an input video signal is switched from 2D video to 3D video.

As shown in FIG. 7C, the input unit 110 receives the video signal same as that in FIG. 7B. Here, for example, it is assumed that the display panel 32 is a 2D display panel, that is, the display frame rate is 60 fps, and the display panel 32 displays 2D video.

Since the frame rate of the 2D video signal is the display frame rate, the output unit 140 outputs the second video signal during the first output period at the frame rate with no change. Furthermore, since the framer rate of the 3D video signal is twice as high as the display frame rate, the output unit 140 thins the left-eye images (L5, L7, L9 . . . ) or the right-eye images (R6, R8, R10 . . . ) and outputs the non-thinned ones during the second output period.

Accordingly, the output unit 140 converts the frame rate of the 3D video signal that is twice as high as the display frame rate into the display frame rate, to output the 3D video signal at the display frame rate. Here, as shown in FIG. 7C, the output unit 140 outputs the 2D video signal and the 3D video signal at the display frame rate so that the display panel 32 displays 2D video. As a result, blackouts do not occur at the time of switching from the 2D video signal to the 3D video signal.

As described, the video signal processing apparatus 100 according to the embodiment has the same frame rate at the time of switching; and thus, it is possible to seamlessly switch between the 2D video signal and the 3D video signal without causing blackouts.

The method of converting the frame rate shown in FIG. 7A to FIG. 7C is merely an example. For example, when the input video signal shown in FIG. 7A is input, the output unit 140 may output both of the 3D video signal and the 2D video signal as 2D video. In the similar manner, when the input video signal shown in FIG. 7B is input, the output unit 140 may output both of the 2D video signal and the 3D video signal as 3D video.

The video signal processing apparatus 100 according to the embodiment determines, based on an instruction from the user or the like, whether to display the 3D video signal as 3D video or 2D video. Thus, for example, even when an input video signal is switched to a 2D video signal while displaying an input 3D video signal as 3D video signal on the display panel 32, it is possible to display the input 2D video signal as 3D video on the display panel 32. Accordingly, it is possible to prevent the user from receiving strange feeling caused due to the sudden switch from the 3D video into the 2D video.

In such a manner, the video signal processing apparatus 100 according to the embodiment can be effectively used when, for example, content, such a movie, which is 3D video is switched to advertisement information, such as commercial, which is 2D video.

Even when an input video signal is switched to a 3D video signal while displaying an input 2D video signal as 2D video on the display panel 32, it is also possible to display the input 3D video signal as 2D video on the display panel 32. When the user views 3D video without wearing the shutter glasses 40, the 3D video looks like two overlapping images for the user. Thus, for example, when the input video signal is suddenly switched from a 2D video signal to a 3D video signal, it is preferable to display as 2D images rather than displaying such overlapping images.

In order to view 3D video, the shutter glasses 40 are necessary. Sometimes, it may be bothersome to wear the shutter glasses 40. In such a case, the video signal processing apparatus 100 according to the embodiment is capable of displaying a 3D video signal as 2D video on the display panel 32; and thus, the user can view images included in the 3D video signal as 2D video without wearing the shutter glasses 40.

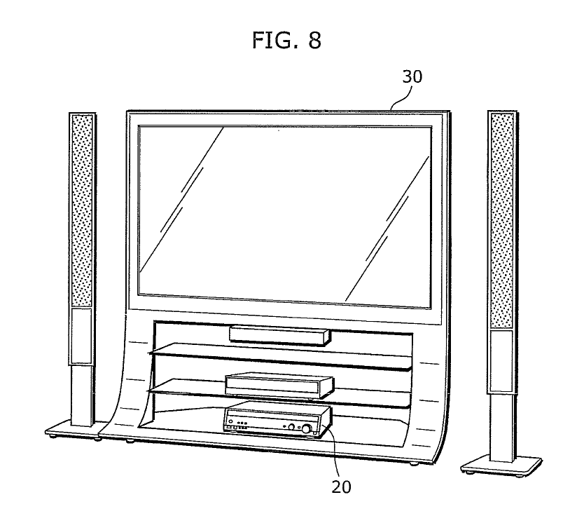

The video signal processing apparatus 100 according to the present invention is incorporated in the digital video recorder 20 and the digital television 30 as shown in FIG. 8.

As described, the video signal processing apparatus 100 according to the embodiment outputs 2D video signals and 3D video signals at the same display frame rate before and after the switching of the 2D video signals and the 3D video signals. Since the frame rate is the same, it is possible to seamlessly switch video signals without causing blackouts at the time of switching of the video signals.

The video signal processing apparatus and the video signal processing method according to the present invention have been described based on the embodiment; however, the present invention is not limited to the embodiment. Those skilled in the art will readily appreciate that many modifications are possible in the exemplary embodiment without materially departing from the novel teachings and advantages of this invention. Accordingly, all such modifications are intended to be included within the scope of this invention.

For example, the display frame rate of the display panel 32 is merely an example, and other frame rates are also possible. Furthermore, in the embodiment, it has been described that the frame rate of the input 2D video signal or 3D video signal is the same as the display frame rate; however, it may also be that the frame rates of both of the 2D video signal and 3D video signal are different from the display frame rate.

In this case, too, the output unit 140 converts the frame rates of the 2D video signal and the 3D video signal to the display frame rate for output. For example, when the frame rate of an input video signal is N times as high as the display frame rate, the output unit 140 outputs one picture out of N pictures, and when the frame rate of an input video signal is 1/N times as high as the display frame rate, the output unit 140 outputs each picture N times in a row.

Furthermore, it has been described that when the input unit 110 obtains a 2D video signal, the obtained 2D video signal is output to either the video decoder 120 or 121; however, the 2D video signal may be output to both of the video decoders 120 and 121. In other words, it may be that the 2D video signal is divided and decoding of the compressed encoded 2D video signals may be performed in parallel. This increases the processing speed.

The present invention has been described based on the embodiment; however, of course, the present invention is not limited to the embodiment. The following cases are also included within the scope of the present invention.

Each of the aforementioned apparatuses is, specifically, a computer system including a microprocessor, a ROM, a RAM, a hard disk unit, a display unit, a keyboard, a mouse, and the so on. A computer program is stored in the RAM or hard disk unit. The respective apparatuses achieve their functions through the microprocessor's operations according to the computer program. Here, with an aim to achieve predetermined functions, the computer program is configured by combining plural instruction codes indicating instructions for the computer.

A part or all of the elements constituting the respective apparatuses may be configured with a single system-LSI (Large-Scale Integration). The system-LSI is a super-multi-function LSI manufactured by integrating constituent units on a single chip, and is specifically a computer system configured to include a microprocessor, a ROM, a RAM, and so on. A computer program is stored in the RAM. The system-LSI achieves its function through the microprocessor's operation according to the computer program.

A part or all of the elements constituting the respective apparatuses may be configured as an IC card which can be attached to and detached from the respective apparatuses or as a stand-alone module. The IC card or the module is a computer system configured from a microprocessor, a ROM, a RAM, and the so on. The IC card or the module may also be included in the aforementioned super-multi-function LSI. The IC card or the module achieves its function through the microprocessor's operation according to the computer program. The IC card or the module may also be implemented to be tamper-resistant.

The present invention may be implemented as a method described above. The present invention may be implemented as computer programs for executing the above-described methods, using a computer, and may also be implemented as digital signals including the computer programs.

Furthermore, the present invention may also be implemented as the aforementioned computer programs or digital signals recorded on a computer readable recording media such as a flexible disc, a hard disk, a CD-ROM, an MO (Magneto-Optical Disk), a DVD (Digital Versatile Disc), a DVD-ROM, a DVD-RAM, a BD, and a semiconductor memory. Furthermore, the present invention may also be implemented as digital signals recorded on these recording media.

Furthermore, the present invention may also be implemented as the aforementioned computer programs or digital signals transmitted via a telecommunication line, a wireless or wired communication line, a network represented by the Internet, a data broadcast, and so on.

The present invention may also be a computer system including a microprocessor and a memory, in which the memory stores the aforementioned computer program and the microprocessor operates according to the computer program.

Furthermore, by transferring the programs or the digital signals recorded on the aforementioned recording media, or by transferring the programs or digital signals via the aforementioned network and the like, execution using another independent computer system is also made possible.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A video signal processing apparatus and a video signal processing method according to the present invention is capable of seamlessly switching between a 2D video signal and a 3D video signal without causing blackouts. For example, the present invention is applicable to a digital television and a digital video recorder.

What is claimed is:

1. A video signal processing apparatus comprising:
an input unit configured to obtain a two-dimensional (2D) video signal and a three-dimensional (3D) video signal, the 2D video signal having a frame rate different from a frame rate of the 3D video signal; and
an output unit configured to (i) convert at least one of the frame rates of the 2D video signal and the 3D video signal obtained by said input unit into a predetermined display frame rate, (ii) output the 2D video signal at the predetermined display frame rate during a first period, and (iii) output the 3D video signal at the predetermined display frame rate during a second period that is consecutive to the first period.

2. The video signal processing apparatus according to claim 1, wherein said input unit is configured to obtain the 2D video signal having a frame rate that is half of the predetermined display frame rate and the 3D video signal having the predetermined display frame rate, and
said output unit is configured to convert the frame rate of the 2D video signal into the predetermined display frame rate.

3. The video signal processing apparatus according to claim 2,
wherein the 2D video signal includes a plurality of 2D images,
said video signal processing apparatus further comprises
a parallax determining unit configured to determine a displacement amount for displacing a position of pixels of each of the 2D images in a horizontal direction, and
said output unit is configured to (i) generate a plurality of images including parallax information by displacing the position of the pixels of each of the 2D images by the displacement amount determined by said parallax determining unit, and (ii) alternately output a picture of each of the generated images including parallax information and a picture of each of the 2D images during the first period.

4. The video signal processing apparatus according to claim 2,
wherein the 2D video signal includes a plurality of 2D images, and
said output unit is configured to output a picture of each of the 2D images twice in a row during the first period.

5. The video signal processing apparatus according to claim 2,
wherein the 3D video signal includes a plurality of left-eye images and a plurality of right-eye images, and
said output unit is configured to output one of (i) a picture of each of the left-eye images and (ii) a picture of each of the right-eye images, twice in a row during the second period.

6. The video signal processing apparatus according to claim 1,
wherein said input unit is configured to obtain the 2D video signal having the predetermined display frame rate, and the 3D video signal having a frame rate twice as high as the predetermined display frame rate, and
said output unit is configured to convert the frame rate of the 3D video signal into the predetermined display frame rate.

7. The video signal processing apparatus according to claim 6,
wherein the 3D video signal includes a plurality of left-eye images and a plurality of right-eye images, and
said output unit is configured to output one of (i) a picture of each of the left-eye images and (ii) a picture of each of the right-eye images, once during the second period.

8. A video signal processing method comprising:
obtaining a two-dimensional (2D) video signal and a three-dimensional (3D) video signal, the 2D video signal having a frame rate different from a frame rate of the 3D video signal; and
converting at least one of the frame rates of the 2D video signal and the 3D video signal obtained in said obtaining into a predetermined display frame rate, outputting the 2D video signal at the predetermined display frame rate during a first period, and outputting the 3D video signal at the predetermined display frame rate during a second period that is consecutive to the first period.

9. An integrated circuit comprising:
an input unit configured to obtain a two-dimensional (2D) video signal and a three-dimensional (3D) video signal, the 2D video signal having a frame rate different from a frame rate of the 3D video signal; and
an output unit configured to (i) convert at least one of the frame rates of the 2D video signal and the 3D video signal obtained by said input unit into a predetermined display frame rate, (ii) output the 2D video signal at the predetermined display frame rate during a first period, and (iii) output the 3D video signal at the predetermined display frame rate during a second period that is consecutive to the first period.

10. A non-transitory computer-readable recording medium for use in a computer, said recording medium having a computer program recorded thereon for causing the computer to execute:
obtaining a two-dimensional (2D) video signal and a three-dimensional (3D) video signal, the 2D video signal having a frame rate different from a frame rate of the 3D video signal; and
converting at least one of the frame rates of the 2D video signal and the 3D video signal obtained in the obtaining into a predetermined display frame rate, outputting the 2D video signal at the predetermined display frame rate during a first period, and outputting the 3D video signal at the predetermined display frame rate during a second period that is consecutive to the first period.
